(19) United States
(12) Patent Application Publication
(10) Pub. No.: US 2021/0142395 A1
(43) Pub. Date: May 13, 2021

(54) RENTAL MANAGEMENT DEVICE FOR WORK MACHINE, RENTAL MANAGEMENT METHOD FOR WORK MACHINE, AND RENTAL MANAGEMENT PROGRAM FOR WORK MACHINE

(71) Applicant: HONDA MOTOR CO., LTD., Tokyo (JP)

(72) Inventors: Akifumi FUJIMA, Wako-shi (JP); Takashi HASHIZUME, Wako-shi (JP); Keiichiro BUNGO, Wako-shi (JP); Hisanori KANAYAMA, Wako-shi (JP)

(73) Assignee: Honda Motor Co., Ltd., Tokyo (JP)

(21) Appl. No.: 17/042,399

(22) PCT Filed: Mar. 30, 2018
(86) PCT No.: PCT/JP2018/013804

§ 371 Date: Sep. 28, 2020

(51) Int. Cl. G06Q 30/06; G06Q 30/02; G06Q 10/02; G06Q 10/00

(52) U.S. Cl. CPC G06Q 30/0645; G06Q 10/20; G06Q 10/02; G06Q 30/0206

(57) ABSTRACT

A work machine rental management device, a work machine rental management method, and a work machine rental program that can appropriately determine a rental cost of a work machine. A controller of a rental management device acquires a total operating time and a maintenance record of a work machine during a rental period, a cumulative operating time of the work machine at the start of the rental period, and maintenance management information including a content of maintenance required for the work machine and a cost required for the maintenance from a ROM. The controller determines a maintenance cost required for the maintenance required during the rental period based on the total operating time, the cumulative operating time, and the maintenance management information, and determines the rental cost during the rental period based on the determined maintenance cost, the total operating time, and the maintenance record.

### TECHNICAL FIELD

The present invention relates to a work machine rental management device, a work machine rental management method, and a work machine rental management program.

### BACKGROUND ART

As a method of setting the rental cost when renting a work machine powered by an engine such as a generator, a pump, an outboard motor, an agricultural work machine such as a lawn mower, a work machine for civil engineering, a transport vehicle, and a snowplow, there are methods disclosed in Patent Literature 1 and Patent Literature 2, for example.

Patent Literature 1 describes a method of determining a rental cost of a construction machine in consideration of not only the period of use of the construction machine but also the degree of wear thereof when calculating the rental cost of the construction machine.

Patent Literature 2 describes a method of determining a rental cost of a construction machine according to a user's past maintenance record of the construction machine and load conditions and usage conditions of the construction machine to be rented from now on.

### RELATED ART LITERATURE

### Patent Literature

Patent Literature 1: JP-A 2002-109027

Patent Literature 2: JP-A 2002-183511

### SUMMARY OF THE INVENTION

### Problem that the Invention is to Solve

Since a work machine requires maintenance, it is desirable for a lender who lends the work machine to shorten the time required for this maintenance as much as possible to shorten a period during which the work machine cannot be lent.

Therefore, it is possible to let a user maintain the work machine during a rental period of the work machine. For example, in Patent Literature 2, in consideration of the past maintenance record of a user, a preferential treatment such as lowering the rental cost is given to the user who appropriately performs maintenance.

However, this method increases or decreases the rental cost based on the past maintenance record. Therefore, it cannot be said that the rental cost for the work machine to be rented is suitable for both the user and the lender. Further, Patent Literature 1 does not set the rental cost in consideration of the maintenance status of the construction machine.

The invention has been made in view of the above circumstances and an object thereof is to provide a work machine rental management device, a work machine rental management method, and a work machine rental program which can appropriately determine the rental cost of a work machine.

### Means for Solving the Problem

A work machine rental management device of the invention is a work machine rental management device which manages a rental cost of a work machine including an engine, the device including a first information acquisition unit which acquires information on a total operating time and a maintenance record of the work machine during a rental period of the work machine, information on a cumulative operating time of the work machine at the start of the rental period, and maintenance management information including information on a content of maintenance required for the work machine and a cost required for the maintenance from a storage unit, a maintenance determination unit which determines a maintenance cost required for the maintenance necessary for the work machine during the rental period based on the total operating time, the cumulative operating time, and the maintenance management information, a rental cost determination unit which determines a rental cost of the work machine during the rental period based on the total operating time, the maintenance record, and the maintenance cost, and an information output unit which outputs information on the rental cost.

A work machine rental management method of the invention is a work machine rental management method which manages a rental cost of a work machine including an engine, the method including the steps of acquiring information on a total operating time and a maintenance record of the work machine during a rental period of the work machine, information on a cumulative operating time of the work machine at the start of the rental period, and maintenance management information including information on a content of maintenance required for the work machine and a cost required for the maintenance from a storage unit, determining a maintenance cost required for the maintenance necessary for the work machine during the rental period based on the total operating time, the cumulative operating time, and the maintenance management information, determining a rental cost of the work machine during the rental period based on the total operating time, the maintenance record, and the maintenance cost, and outputting information on the rental cost.

A work machine rental management program, for rental cost management of a work machine including an engine, causing a computer to execute process including the steps of acquiring information on a total operating time and a maintenance record of the work machine during a rental period of the work machine, information on a cumulative operating time of the work machine at the start of the rental period, and maintenance management information including information on a content of maintenance required for the work machine and a cost required for the maintenance from a storage unit, determining a maintenance cost required for the maintenance necessary for the work machine during the rental period based on the total operating time, the cumulative operating time, and the maintenance management information, determining a rental cost of the work machine during the rental period based on the total operating time, the maintenance record, and the maintenance cost, and outputting information on the rental cost.

### Advantages of the Invention

According to the invention, it is possible to provide a work machine rental management device, a work machine rental management method, and a work machine rental program that can appropriately determine the rental cost of a work machine.

### BRIEF DESCRIPTION OF DRAWINGS

FIG. 1 is a schematic diagram illustrating a schematic configuration of a work machine rental system including a rental management device which is an embodiment of a work machine rental management device of present invention.

FIG. 2 is a block diagram schematically illustrating an example of a detailed configuration of a work machine illustrated in FIG. 1.

FIG. 3 is a block diagram illustrating an internal configuration of the rental management device illustrated in FIG. 1.

FIG. 4 is a diagram illustrating an example of maintenance management information stored in a second storage area of a ROM illustrated in FIG. 3.

FIG. 5 is a functional block diagram of a controller illustrated in FIG. 3.

FIG. 6 is a flowchart for illustrating an operation of determining a rental cost of the work machine by the controller illustrated in FIG. 3.

FIG. 7 is a diagram illustrating a modification example of functional blocks of the controller 11 illustrated in FIG. 3.

### MODE FOR CARRYING OUT THE INVENTION

Embodiments of the invention will be described below with reference to the drawings.

FIG. 1 is a schematic diagram illustrating a schematic configuration of a work machine rental system 100 including a rental management device 1 which is an embodiment of a rental management device of the invention.

The work machine rental system 100 includes the rental management device 1, a work machine 2 lent by an administrator of the rental management device 1, and a user terminal 3 owned by a user who rents the work machine 2 and those are configured to be connectable to an Internet 4.

The user terminal 3 is an electronic device having an Internet connection function such as a personal computer or a smartphone.

The work machine rental system 100 allows a user who rents the work machine 2 to perform maintenance on the work machine 2, thereby making it possible to reduce the total cost of renting the work machine 2.

FIG. 2 is a block diagram schematically illustrating an example of a detailed configuration of the work machine 2 illustrated in FIG. 1. FIG. 2 illustrates an example in which the work machine 2 is an engine pump. However, the work machine 2 is not limited to the engine pump and may be a machine which executes various functions using the engine as a power source. For example, the work machine 2 may be a generator, an outboard motor, an agricultural work machine such as a lawn mower, a work machine for civil engineering, a transport vehicle, or a snowplow.

As illustrated in FIG. 2, the work machine 2 includes a liquid pump 2A and an engine device 2B. The engine device 2B includes an engine 21 serving as a power source of the liquid pump 2A, a communication interface (I/F) 22, an Electronic Control Unit (ECT) 23, and an operating device 24.

The engine 21 is, for example, an air-cooled 2-cycle or 4-cycle single-cylinder engine which uses gasoline as fuel. The engine 21 is connected to a bus 20 and controlled by the ECU 23.

The communication I/F 22 is an interface for communicating with other devices connected to the Internet 4. The communication I/F 22 is connected to the bus 20 and controlled by the ECU 23.

The operating device 24 is hardware for performing various operations of the work machine 2. The operating device 24 includes a power button for starting or stopping the engine device 2B, a suction start/end button for instructing start or stop of liquid suction by the liquid pump 2A, a keyboard for inputting information, and the like.

The ECU 23 is configured by a microcomputer including a processor, a Read Only Memory (ROM) in which a control program executed by the processor is stored, and a Random Access Memory (RAM). The ECU 23 operates by the power of a battery (not illustrated) that is charged by the power of the engine 21.

The ECU 23 is activated by the electric power supplied from the battery when the activation instruction is given by the operation of the power button included in the operating device 24 and controls the communication I/F 22 to obtain a communicable state with other electronic devices.

While the engine 21 is being driven, the ECU 23 adjusts the opening degree of a throttle valve included in the engine 21 so that the liquid delivery amount of the liquid pump 2A per unit time reaches a desired target value.

The liquid pump 2A includes a pump mechanism 25.

The pump mechanism 25 has a housing having two openings, a liquid inlet and a liquid outlet, and an impeller arranged in the housing and rotated by the power of the engine 21. The pump mechanism 25 is a mechanism which, by the operation of the impeller, discharges the liquid that has flowed into the housing through the liquid inlet from the liquid outlet.

The ECU 23 stores, in the ROM, the usage record information on the work machine 2, such as the operating history (information indicating how long it has been operating) of the work machine 2, the average rotation speed of the engine 21 in operation, and the average load of the engine 21 in operation. The ECU 23 transmits the usage record information stored in the ROM to the rental management device 1 via the communication I/F 22.

Further, when the maintenance (exchange of consumables such as oil or exchange of components) of the work machine 2 is performed, the ECU 23 generates the maintenance record information including the date and time when the maintenance is performed and the content of the maintenance and stores it in the ROM. The ECU 23 sends this maintenance record information to the rental management device 1 via the communication interface 22.

FIG. 3 is a block diagram illustrating an internal configuration of the rental management device 1 illustrated in FIG. 1.

The rental management device 1 includes a controller 11 which controls the entire device, a ROM 12 such as a flash memory which constitutes a storage unit, a RAM 13, a communication interface (I/F) 14, an operation unit 15, and an output device 16. The ROM 12, the RAM 13, the communication I/F 14, the operation unit 15, and the output device 16 are connected to a bus 10 and controlled by the controller 11.

The communication I/F 14 is an interface for communicating with other devices connected to the Internet 4.

The operation unit 15 is hardware for performing various operations of the rental management device 1 and includes a mouse, buttons, a touch panel, a keyboard or the like for inputting information.

The output device 16 is hardware for outputting information to the outside and is a display device which displays an image by a liquid crystal panel or an organic electro-luminance (EL) panel, or a printer which prints information on a medium such as paper.

In the controller 11, the hardware structure is composed of various processors. The various processors include a Central Processing Unit (CPU), which is a general-purpose processor that executes programs to perform various processes, a Programmable Logic Device (PLD) such as an Field Programmable Gate Array (FPGA), which is a processor whose circuit configuration can be changed after manufacturing, and a dedicated electric circuit such as an Application Specific Integrated Circuit (ASIC), which is a processor having a circuit configuration specifically designed to execute a specific process.

More specifically, the structures of those various processors are electric circuits in which circuit elements such as semiconductor elements are combined.

The controller 11 may be configured by one of various processors or may be configured by a combination (for example, a combination of a plurality of FPGAs or a combination of CPU and FPGA) of two or more processors of the same type or different types.

The ROM 12 stores programs including a rental management program executed by the controller 11. Further, the ROM 12 includes a first storage area 12a, a second storage area 12b, a third storage area 12c, and a fourth storage area 12d.

In the first storage area 12a, for each work machine 2 to be loaned, the information on the usage record and maintenance record of the work machine 2 during the rental period and the information on the cumulative operating time of the work machine 2 at the start of the rental period are stored.

In the second storage area 12b, for each work machine 2 to be loaned, the maintenance management information including information on the contents of the maintenance necessary for the work machine 2, the time of performing the maintenance, and the maintenance cost of the maintenance is stored in advance.

FIG. 4 is a diagram illustrating an example of the maintenance management information stored in the second storage area 12b.

As illustrated in FIG. 4, the maintenance management information includes maintenance execution timing information (500 hours, 1000 hours, 1500 hours, 2000 hours) which indicates how long the work machine 2 should run for maintenance, information indicating the contents of maintenance such as oil exchange or parts exchange, and information on maintenance costs required to perform maintenance.

The maintenance cost information is stored with expenses (for example, parts cost+labor cost) that may occur when the administrator of the rental management device 1 performs the corresponding maintenance.

In the third storage area 12c of the ROM 12, reference cost information indicating the rental cost of the work machine 2 per unit operating time (hereinafter, for example, one hour) is stored in advance.

In the fourth storage area 12d, the individual information (including the user ID, the identification ID of the work machine 2 to rent, and information on the rental period during which the rental is performed) of a user who uses the work machine rental system 100 is stored under the control of the controller 11.

The individual information may be input by an operator directly to the controller 11 by operating the operation unit 15 at the timing when a user signs a rental contract or by a user from the WEB page displayed on the user terminal 3 to the controller 11 via the Internet 4.

When the individual information is stored in the fourth storage area 12d, the information (information stored in the first storage area 12a) on the cumulative operating time of the work machine 2 specified by the identification ID of the work machine 2 included in the individual information is stored in the fourth storage area 12d in association with the individual information. The information on the cumulative operating time stored in the fourth storage area 12d is the information on the cumulative operating time of the work machine 2 at the start of the rental period of the work machine 2.

The controller 11 of the rental management device 1 illustrated in FIG. 3 generates, for the work machine 2, support information that prompts a user to perform maintenance on the work machine 2 based on the maintenance management information stored in the third storage area 12c. Next, the controller 11 sends the support information to the user terminal 3 via the Internet 4.

For example, the controller 11 periodically acquires information on the total operating time at that time from the work machine 2 during the rental period, and then the controller 11 calculates the latest cumulative operating time from the total operating time and the cumulative operating time stored in the first storage area 12a. Next, when the latest cumulative operating time matches the maintenance execution timing time included in the maintenance management information, the controller 11 generates an e-mail and sends it to the user terminal 3 as the support information for urging the maintenance of the content corresponding to the maintenance execution timing.

By this e-mail, the user who owns the user terminal 3 can know when it is time to perform maintenance and the content of the required maintenance.

This support information may be transmitted to the work machine 2. For example, the work machine 2 may be provided with a display unit and the support information may be displayed on the display unit. With such a mechanism, it is possible to have a user who rents the work machine 2 perform maintenance of the work machine 2 at an appropriate timing.

FIG. 5 is a functional block diagram of the controller 11 illustrated in FIG. 3.

The controller 11 functions as a storage control unit 11F, a first information acquisition unit 11A, a maintenance determination unit 11B, a rental cost determination unit 11C, and an information output unit 11D by executing the program including the rental management program of the work machine.

The controller 11 functions as the storage control unit 11F, the first information acquisition unit 11A, the maintenance determination unit 11B, the rental cost determination unit 11C, and the information output unit 11D by executing the program including the rental management program of the work machine when a user returns the work machine 2 and an operator performs a predetermined operation (operation to instruct payment of rental cost) via the operation unit 15.

When the predetermined operation described above is performed, the work machine 2 transmits the information on the usage record and the maintenance record to the rental management device 1.

When the storage control unit 11F of the controller 11 receives the above-described usage record information from the work machine 2, it extracts the usage record during the rental period associated with the user ID of a user who rented the work machine 2 from the information. Next, the storage control unit 11F calculates the total operating time during the rental period of the work machine 2, the average rotation speed during the rental period of the engine 21 of the work machine 2, and the average load during the rental period of the engine 21 of the work machine 2 from the extracted usage record, and then the storage control unit 11F stores those in the first storage area 12a in association with the user ID and the identification ID of the work machine 2.

Further, when the storage control unit 11F of the controller 11 receives the above-described usage record information from the work machine 2, the storage control unit 11F adds the above-described total operating time associated with the user ID to the cumulative operating time corresponding to the identification ID of the work machine 2 stored in the first storage area 12a to update the cumulative operating time of the work machine 2.

When the storage control unit 11F of the controller 11 receives the above-described maintenance record information from the work machine 2, it extracts, from this information, information on the maintenance record during the rental period associated with the user ID of a user who rented the work machine 2. Then, the storage control unit 11F stores the extracted maintenance record information in the first storage area 12a in association with the user ID and the identification ID of the work machine 2.

The first information acquisition unit 11A reads out and acquires, from the fourth storage area 12d, information on the cumulative operating time at the start of the rental period of the work machine 2 corresponding to the identification ID of the work machine 2 included in the individual information including the user ID of the user.

Further, the first information acquisition unit 11A reads out and acquires, from the first storage area 12a, information on the total operating time and the maintenance record in the rental period of the work machine 2, which corresponds to the identification ID of the work machine 2.

Further, the first information acquisition unit 11A reads out and acquires the maintenance management information of the work machine 2 from the third storage area 12c.

Based on the total operating time acquired by the first information acquisition unit 11A, the cumulative operating time at the start of the rental period of the work machine 2, and the maintenance management information, the maintenance determination unit 11B determines the maintenance cost required for the maintenance of the work machine 2 required during the rental period.

For example, a case where the rental period is one month and the total operating time of the work machine 2 during the rental period is 200 hours, and further the cumulative operating time of the work machine 2 at the start of the rental period is 900 hours will be described.

In this case, the cumulative operating time of the work machine 2 is 1100 hours at the end of the rental period. Therefore, according to the maintenance management information illustrated in FIG. 4, during this rental period, the maintenance determination unit 11B determines that the maintenance content (oil exchange and component exchange) corresponding to the maintenance execution timing of “1000 hours” is necessary and the maintenance cost corresponding to the content of this maintenance is determined by the maintenance determination unit 11B as the maintenance cost for this maintenance.

Alternatively, when the total operating time of the work machine 2 during the rental period is 650 hours and the cumulative operating time of the work machine 2 at the start of the rental period is 900 hours, the maintenance content and maintenance cost corresponding to “1000 hours” of the maintenance management information illustrated in FIG. 4 and the maintenance content and maintenance cost corresponding to “1500 hours” of the maintenance management information illustrated in FIG. 4 are determined by the maintenance determination unit 11B as information of maintenance required during the rental period.

Based on the information on the total operating time and the maintenance record during the rental period acquired by the first information acquisition unit 11A and the maintenance cost determined by the maintenance determination unit 11B, the rental cost determination unit 11C determines the rental cost of the work machine 2.

The information output unit 11D outputs information on the rental cost determined by the rental cost determination unit 11C to the output device 16. As a result, the rental cost information is displayed on the display device or printed on paper.

The information output unit 11D may output the rental cost information to the user terminal 3 via the communication I/F 14 and display this information on the display unit of the user terminal 3.

FIG. 6 is a flowchart for illustrating the operation of determining the rental cost of the work machine 2 by the controller 11 illustrated in FIG. 3.

When the operation unit 15 of the rental management device 1 is operated to settle the rental cost of the work machine 2, information on the total operating time, the average rotation speed of the engine, and the average load of the engine during the rental period of the work machine 2 is stored in the first storage area 12a by the storage control unit 11F of the controller 11 and the cumulative operating time of the first storage area 12a is updated by the information on the total operating time.

After that, the first information acquisition unit 11A of the controller 11 acquires information on the cumulative operating time of the work machine 2 at the start of the rental period of the work machine 2 from the fourth storage area 12d of the ROM 12 (step S1).

Further, the first information acquisition unit 11A of the controller 11 acquires information on the total operating time and the maintenance record of the work machine 2 during the rental period from the first storage area 12a of the ROM 12 (step S2).

Further, the first information acquisition unit 11A of the controller 11 acquires the maintenance management information of the work machine 2 from the second storage area 12b of the ROM 12 (step S3).

Next, based on the cumulative operating time acquired in step S1, the total operating time acquired in step S2, and the maintenance management information acquired in step S3, the maintenance determination unit 11B of the controller 11 determines the maintenance content of the work machine 2 required during the rental period of the work machine 2 and the maintenance cost of the maintenance (step S4).

Next, based on the information on the total operating time acquired in step S2 and the reference cost information stored in the third storage area 12c, the rental cost determination unit 11C of the controller 11 determines the reference rental cost during the rental period (step S5).

Specifically, the rental cost determination unit 11C of the controller 11 determines the value obtained by multiplying the total operating time by the reference cost information as the reference rental cost. This reference rental cost is a cost determined by considering only the total operating time (time used by the user) of the work machine 2.

In addition, the rental cost determination unit 11C of the controller 11 may determine the reference rental cost by the product of a value obtained by multiplying the reference cost information by a coefficient (value greater than 0 and less than or equal to 1) corresponding to the size of the cumulative operating time acquired in step S1 and the total operating time.

This coefficient is set to a smaller value as the cumulative operating time is longer. By doing so, the older the work machine 2 that has been used for a long time, the lower the reference rental cost can be.

Next, the rental cost determination unit 11C of the controller 11 determines whether the maintenance content of the work machine 2 determined in step S4 matches the maintenance record acquired in step S2 (step S6).

When the maintenance content and the maintenance record match, it means that at least one maintenance content included in the maintenance record information and the at least one maintenance content determined in step S4 all match.

When the maintenance content and the maintenance record match (step S6: YES), the rental cost determination unit 11C of the controller 11 determines the reference rental cost determined in step S5 as the final rental cost of the work machine 2 (step S7).

After step S7, this final rental cost is output by the information output unit 11D of the controller 11 (step S9) and the final rental cost is presented to the user.

On the other hand, when the maintenance content and the maintenance record do not match (step S6: NO), the rental cost determination unit 11C of the controller 11 determines the cost obtained by adding at least a part of the maintenance cost determined in step S4 to the reference rental cost determined in step S5 as the final rental cost of the work machine 2. (Step S8). After step S8, the process of step S9 is performed.

For example, it can be considered a case where the maintenance content determined in step S4 is two, namely the maintenance content A and the maintenance content B, and the maintenance content included in the maintenance record is maintenance content A. In this case, since the maintenance record does not include the maintenance content B, the determination in step S6 is NO.

Then, in step S8, only the maintenance cost corresponding to the maintenance content B among the maintenance costs corresponding to each of the maintenance content A and the maintenance content B determined in step S4 is added to the reference rental cost determined in step S5, in such a manner that the final rental cost is determined.

Alternatively, for example, it can be considered a case in which the maintenance content determined in step S4 is two, that is, the maintenance content A and the maintenance content B, and the maintenance content included in the maintenance record is zero (if not maintained by a user). In this case, since the maintenance record does not include the maintenance content A and the maintenance content B, the determination in step S6 is NO.

Then, in step S8, the final rental cost is determined by adding the maintenance cost corresponding to each of the maintenance content A and the maintenance content B determined in step S4 to the reference rental cost determined in step S5.

As described above, according to the rental management device 1, when the maintenance of the work machine 2 is required during the rental period of the work machine 2 and all necessary maintenance is performed by a user, only the reference rental cost is charged to the user.

On the other hand, when the required maintenance is only partially or not performed by a user, the reference rental cost will be charged to the user in addition to the maintenance cost of the required maintenance that has not been performed.

According to this system, for a user, by devising the maintenance cost to keep it low, the total cost of renting the work machine 2 can be suppressed as compared with the case of paying the maintenance cost to the lender.

In particular, when the cumulative operating time at the start of the rental period of the work machine 2 becomes large (work machine 2 is worn out), the type of maintenance content and the frequency of maintenance also increase. Therefore, the effect of reducing the maintenance cost by a user can be enhanced.

As described above, the maintenance of the work machine 2 by a user can reduce the total cost of rental, and thus the user can be strongly encouraged to perform the maintenance. Therefore, the lender can reduce the period during which the work machine 2 cannot be loaned for maintenance, and thus the work machine 2 can be efficiently operated.

Further, a user can increase the usable time of the work machine 2 during the rental period by devising and shortening the maintenance time, and thus the work machine 2 can be efficiently used.

Further, according to the work machine rental system 100, the rental cost of the work machine 2 during the rental period is determined in consideration of the maintenance record of the work machine 2 performed by a user during the rental period. Therefore, as compared with the case where the rental cost for the future rental period is determined from the past maintenance record as in the related art, it is possible to determine the appropriate rental cost for both the user and the lender.

According to the work machine rental system 100, when a user wants to use the work machine 2 as long as possible during the rental period, the user can make a decision so as not to perform maintenance, and when a user wants to use the work machine 2 as cheaply as possible during the rental period, the user can make a decision such as performing maintenance himself or herself, in such a manner that the user will be able to respond flexibly. As a result, it is possible to improve convenience.

FIG. 7 is a diagram illustrating a modification example of functional blocks of the controller 11 illustrated in FIG. 3. In FIG. 7, the components having the same functions as those in FIG. 3 are designated by the same reference letters and numerals.

By executing programs including the work machine rental management program, the controller 11 illustrated in FIG. 7 functions as the first information acquisition unit 11A, a second information acquisition unit 11E, the maintenance determination unit 11B, the rental cost determination unit 11C, the information output unit 11D, and the storage control unit 11F.

The second information acquisition unit 11E reads out and acquires information on the degree of wear of the work machine 2 during the rental period from the first storage area 12a of the ROM 12.

The degree of wear is, for example, an average value of the engine rotation speed during the rental period of the work machine 2 or an average value of the engine loads during the rental period. The higher the average value of the engine rotation speed and the engine loads, the higher the degree of wear.

The rental cost determination unit 11C illustrated in FIG. 7 calculates the reference rental cost based on the total operating time of the work machine 2 during the rental period and the degree of wear of the work machine 2. For example, it is assumed that the degree of wear is set as a value greater than 0 and equal to or less than 1 and a value obtained by multiplying the reference cost information, the degree of wear, and the total operating time is determined as the reference rental cost.

According to the above-described configuration of the controller 11 illustrated in FIG. 7, the reference rental cost can be set to a more appropriate value according to the usage state of the work machine 2, and thus it becomes possible for both the user and the lender to determine an appropriate rental cost.

The invention is not limited to the embodiments described above, but can be modified and improved as appropriate.

As described above, the following items are disclosed in this specification.

(1) A work machine rental management device which manages a rental cost of a work machine including an engine, including:

a first information acquisition unit which acquires information on a total operating time and a maintenance record of the work machine during a rental period of the work machine, information on a cumulative operating time of the work machine at the start of the rental period, and maintenance management information including information on a content of maintenance required for the work machine and a cost required for the maintenance from a storage unit;

a maintenance determination unit which determines a maintenance cost required for the maintenance necessary for the work machine during the rental period based on the total operating time, the cumulative operating time, and the maintenance management information;

a rental cost determination unit which determines a rental cost of the work machine during the rental period based on the total operating time, the maintenance record, and the maintenance cost; and

an information output unit which outputs information on the rental cost.

According to (1), the rental cost of the work machine is determined based on the total operating time, the maintenance record, and the maintenance cost. In this way, by considering the maintenance record and the maintenance cost in determining the rental cost, for example, it is possible to realize the flexible cost setting that does not charge a user who has performed maintenance for the cost required for the maintenance and charges a user who did not perform maintenance by including the cost required for the maintenance in the rental cost. For a user, there is an advantage that the total cost for renting the work machine can be suppressed by reducing the maintenance cost with effort. Since the lender of the work machine can prompt a user for maintenance, it is possible to reduce the period during which the work machine is maintained and cannot be rented. Therefore, the efficient operation becomes possible. Moreover, since the rental cost is determined based on the maintenance record in the rental period, it is possible to determine the proper rental cost for both the user and the lender.

(2) The work machine rental management device according to (1), where

the maintenance determination unit further determines a maintenance content of the work machine required during the rental period, and

the rental cost determination unit determines a reference rental cost based on at least information on the total operating time and further determines whether the maintenance content of the work machine determined by the maintenance determination unit and the maintenance record match, and then when the maintenance content and the maintenance record match, the reference rental cost is determined as the rental cost of the work machine, and when the maintenance content and the maintenance record do not match, a cost obtained by adding at least a part of the determined maintenance cost to the reference rental cost is determined as the rental cost of the work machine.

According to (2), it is possible to realize the flexible cost setting that does not charge a user who has performed maintenance for the cost required for the maintenance and charges a user who did not perform maintenance by including the cost required for the maintenance in the rental cost. Therefore, for a user, there are advantages such as suppressing the total cost of renting the work machine and extending the usage time of the work machine during the rental period, and for a lender of the work machine, there is an advantage that it can be operated efficiently.

(3) The work machine rental management device according to (2), where

the rental cost determination unit determines the cost to be added to the reference rental cost based on a difference between the maintenance record and the maintenance content when the maintenance content and the maintenance record do not match.

According to (3), when a user performs only a part of the maintenance, it is possible not to charge the user for the cost of the performed maintenance. Therefore, the user can flexibly operate the work machine 2 according to the situation.

(4) The work machine rental management device according to (2) or (3), further including;

a second information acquisition unit for acquiring information on a degree of wear of the work machine during the rental period from the storage unit, and where

the rental cost determination unit determines the reference rental cost based on the information on the total operating time and information on the degree of wear.

According to (4), the rental cost can be made more appropriate.

(5) A work machine rental management method which manages a rental cost of a work machine including an engine, including the steps of:

acquiring information on a total operating time and a maintenance record of the work machine during a rental period of the work machine, information on a cumulative operating time of the work machine at the start of the rental period, and maintenance management information including information on a content of maintenance required for the work machine and a cost required for the maintenance from a storage unit;

determining a maintenance cost required for the maintenance necessary for the work machine during the rental period based on the total operating time, the cumulative operating time, and the maintenance management information;

determining a rental cost of the work machine during the rental period based on the total operating time, the maintenance record, and the maintenance cost; and

outputting information on the rental cost.

According to (5), the rental cost of the work machine is determined based on the total operating time, the maintenance record, and the maintenance cost. In this way, by considering the maintenance record and the maintenance cost in determining the rental cost, for example, it is possible to realize the flexible cost setting that does not charge a user who has performed maintenance for the cost required for the maintenance and charges a user who did not perform maintenance by including the cost required for the maintenance in the rental cost. For a user, there is an advantage that the total cost for renting the work machine can be suppressed by reducing the maintenance cost with effort. Since the lender of the work machine can prompt a user for maintenance, it is possible to reduce the period during which the work machine is maintained and cannot be rented. Therefore, the efficient operation becomes possible. Moreover, since the rental cost is determined based on the maintenance record in the rental period, it is possible to determine the proper rental cost for both the user and the lender.

(6) A work machine rental program for causing a computer to execute rental cost management of a work machine including an engine, including the steps of:

acquiring information on a total operating time and a maintenance record of the work machine during a rental period of the work machine, information on a cumulative operating time of the work machine at the start of the rental period, and maintenance management information including information on a content of maintenance required for the work machine and a cost required for the maintenance from a storage unit;

determining a maintenance cost required for the maintenance necessary for the work machine during the rental period based on the total operating time, the cumulative operating time, and the maintenance management information;

determining a rental cost of the work machine during the rental period based on the total operating time, the maintenance record, and the maintenance cost; and

outputting information on the rental cost.

According to (6), the rental cost of the work machine is determined based on the total operating time, the maintenance record, and the maintenance cost. In this way, by considering the maintenance record and the maintenance cost in determining the rental cost, for example, it is possible to realize the flexible cost setting that does not charge a user who has performed maintenance for the cost required for the maintenance and charges a user who did not perform maintenance by including the cost required for the maintenance in the rental cost. For a user, there is an advantage that the total cost for renting the work machine can be suppressed by reducing the maintenance cost with effort. Since the lender of the work machine can prompt a user for maintenance, it is possible to reduce the period during which the work machine is maintained and cannot be rented. Therefore, the efficient operation becomes possible. Moreover, since the rental cost is determined based on the maintenance record in the rental period, it is possible to determine the proper rental cost for both the user and the lender.

### INDUSTRIAL APPLICABILITY

According to the invention, it is possible to provide a work machine rental management device, a work machine rental management method, and a work machine rental program, which can appropriately determine the rental cost of a work machine.

### DESCRIPTION OF REFERENCE NUMERALS AND CHARACTERS

100: work machine rental system
1: rental management device
2: work machine
3: user terminal
4: Internet
2A: liquid pump
2B: engine device
20: bus
21: engine
22: communication I/F
23: ECU
24: operating device
25: pump mechanism
10: bus
11: controller
11A: first information acquisition unit
11B: maintenance determination unit
11C: rental cost determination unit
11D: information output unit
11E: second information acquisition unit
12: ROM
12a: first storage area
12b: second storage area
12c: third storage area
12d: fourth storage area
13: RAM
14: communication I/F
15: operation unit
16: output device

1. A work machine rental management device which manages a rental cost of a work machine including an engine, comprising:
a first information acquisition unit which acquires information on a total operating time and a maintenance record of the work machine during a rental period of the work machine, information on a cumulative operating time of the work machine at the start of the rental period, and maintenance management information including information on a content of maintenance required for the work machine and a cost required for the maintenance from a storage unit;
a maintenance determination unit which determines a maintenance cost required for the maintenance necessary for the work machine during the rental period based on the total operating time, the cumulative operating time, and the maintenance management information;
a rental cost determination unit which determines a rental cost of the work machine during the rental period based on the total operating time, the maintenance record, and the maintenance cost; and
an information output unit which outputs information on the rental cost.

2. The work machine rental management device according to claim 1, wherein:
the maintenance determination unit further determines a maintenance content of the work machine required during the rental period; and
the rental cost determination unit determines a reference rental cost based on at least information on the total operating time and further determines whether the maintenance content of the work machine determined by the maintenance determination unit and the maintenance record match, and then when the maintenance content and the maintenance record match, the reference rental cost is determined as the rental cost of the work machine, and when the maintenance content and the maintenance record do not match, a cost obtained by adding at least a part of the determined maintenance cost to the reference rental cost is determined as the rental cost of the work machine.

3. The work machine rental management device according to claim 2, wherein
the rental cost determination unit determines the cost to be added to the reference rental cost based on a difference between the maintenance record and the maintenance content when the maintenance content and the maintenance record do not match.

4. The work machine rental management device according to claim 2, further comprising
a second information acquisition unit for acquiring information on a degree of wear of the work machine during the rental period from the storage unit, wherein
the rental cost determination unit determines the reference rental cost based on the information on the total operating time and information on the degree of wear.

5. A work machine rental management method which manages a rental cost of a work machine including an engine, comprising:
acquiring information on a total operating time and a maintenance record of the work machine during a rental period of the work machine, information on a cumulative operating time of the work machine at the start of the rental period, and maintenance management information including information on a content of maintenance required for the work machine and a cost required for the maintenance from a storage unit;
determining a maintenance cost required for the maintenance necessary for the work machine during the rental period based on the total operating time, the cumulative operating time, and the maintenance management information;
determining a rental cost of the work machine during the rental period based on the total operating time, the maintenance record, and the maintenance cost; and
outputting information on the rental cost.

6. A computer program product, for rental cost management of a work machine including an engine, comprising a non-transitory computer readable storage medium having instructions encoded thereon that, when executed by a processor, cause the processor to execute process comprising:
acquiring information on a total operating time and a maintenance record of the work machine during a rental period of the work machine, information on a cumulative operating time of the work machine at the start of the rental period, and maintenance management information including information on a content of maintenance required for the work machine and a cost required for the maintenance from a storage unit;
determining a maintenance cost required for the maintenance necessary for the work machine during the rental period based on the total operating time, the cumulative operating time, and the maintenance management information;
determining a rental cost of the work machine during the rental period based on the total operating time, the maintenance record, and the maintenance cost; and
outputting information on the rental cost.

7. The work machine rental management device according to claim 3, further comprising
a second information acquisition unit for acquiring information on a degree of wear of the work machine during the rental period from the storage unit, wherein
the rental cost determination unit determines the reference rental cost based on the information on the total operating time and information on the degree of wear.
